(19) United States
(12) Patent Application Publication
(10) Pub. No.: US 2020/0254545 A1
(43) Pub. Date: Aug. 13, 2020

(54) ONE-PIECE REAMER CUTTING DISCS AND TOOL BODIES

(71) Applicant: Kennametal Inc., Latrobe, PA (US)

(72) Inventors: Li NING, Pleasant Unity, PA (US); Michael SCHUFFENHAUER, Fuerth (DE)

(21) Appl. No.: 16/270,896

(22) Filed: Feb. 8, 2019

(51) Int. Cl. B23D 77/00

(52) U.S. Cl. CPC B23D 77/00; B23D 2277/206

(57) ABSTRACT

One-piece reamer cutting discs including integral engagement and cutting portions are disclosed. The engagement portion may allow for torque transmission and alignment of the reamer cutting disc on a reamer tool body. The integral engagement portion and cutting portion allows for the cutting portion to be provided closer to the end of the tool body. The one-piece reamer cutting discs may be mounted on a tool body having coolant outlets that direct coolant from the tool body to the exterior surface of the cutting disc.

### FIELD OF THE INVENTION

The present invention relates to reamers, and more particularly relates to reamer cutting discs and reamer tool bodies.

### BACKGROUND INFORMATION

Modular rotary cutting tools, such as modular reamers, typically include two pieces, namely, a reamer cutting head portion and a shank portion. In conventional designs for reamer cutting heads the reamer cutting head comprises a steel base portion and wear-resistant material cutting portion. The wear-resistant material cutting portion is typically brazed onto the steel base portion which results in costly and time-consuming manufacturing process. The steel base portion generally includes an engagement portion to be received within a bore of the shank portion.

### SUMMARY OF THE INVENTION

One-piece reamer cutting discs are provided that include an engagement portion integrally formed with a cutting portion. The one-piece design provides high rigidity throughout the axial length of the reamer cutting disc and flexibility in the geometry of the cutting portion. The engagement portion may allow for torque transmission and alignment of the reamer cutting disc on a reamer tool body. The one-piece design may provide stronger torque transmission coupling with tool body. In certain embodiments, integrally forming the engagement portion and the cutting portion from the same material allows for the cutting portion to be provided closer to the end of the tool body and reduces the complexity of the manufacturing process. The one-piece reamer cutting discs may be mounted on a tool body having coolant outlets that direct coolant from the tool body to the exterior surface of the cutting disc.

An aspect of the present invention is to provide a reamer cutting disc and tool body assembly comprising a tool body comprising an axial forward end having a first socket portion and a second socket portion adjacent to the first socket portion, and a reamer cutting disc engageable with the tool body comprising a cutting portion comprising a generally planar front face, a generally planar rear face and a longitudinally-extending outer edge, and an engagement shank extending from the generally planar rear face of the cutting portion comprising a torque transmission portion adjacent to the generally planar rear face and an alignment portion adjacent to the torque transmission portion, wherein the reamer cutting disc does not include internal coolant channels.

Another aspect of the present invention is to provide a reamer cutting disc comprising a cutting portion comprising a generally planar front face, a generally planar rear face and a longitudinally-extending outer edge, and an engagement shank integrally formed with the cutting portion extending from the generally planar rear face of the cutting portion comprising a torque transmission portion adjacent to the generally planar rear face and an alignment portion adjacent to the torque transmission portion.

These and other aspects of the present invention will be more apparent from the following description.

### BRIEF DESCRIPTION OF THE DRAWINGS

FIG. 1 is a front isometric view of a reamer cutting disc and tool body assembly in accordance with an embodiment of the present invention.

FIG. 2 is a rear isometric view of a reamer cutting disc and tool body assembly of FIG. 1.

FIG. 3 is a front view of the reamer cutting disc and tool body assembly of FIG. 1.

FIG. 4 is a rear view of the reamer cutting disc and tool body assembly.

FIG. 5 is a side view of reamer cutting disc and tool body assembly of FIG. 1.

FIG. 6 is a side-sectional view of the reamer cutting disc and tool body assembly taken through line 6-6 of FIG. 5.

FIG. 7 is a magnified view of a portion of FIG. 6.

FIG. 8 is a cross-sectional view of the reamer cutting disc and tool body assembly taken through line 8-8 of FIG. 5.

FIG. 9 is a cross-sectional view of the reamer cutting disc and tool body assembly taken through line 9-9 of FIG. 5.

FIG. 10 is a side view of tool body in accordance with an embodiment of the present invention.

FIG. 11 is a side-sectional view of the tool body taken through line 11-11 of FIG. 10.

FIG. 12 is a front view of a tool body of FIG. 10.

FIG. 13 is a top isometric view of a reamer cutting disc in accordance with an embodiment of the present invention.

FIG. 14 is a side view of the reamer cutting disc of FIG. 13.

FIG. 15 is a front view of the reamer cutting disc of FIG. 13.

FIG. 16 is a rear view of the reamer cutting disc of FIG. 13.

### DETAILED DESCRIPTION

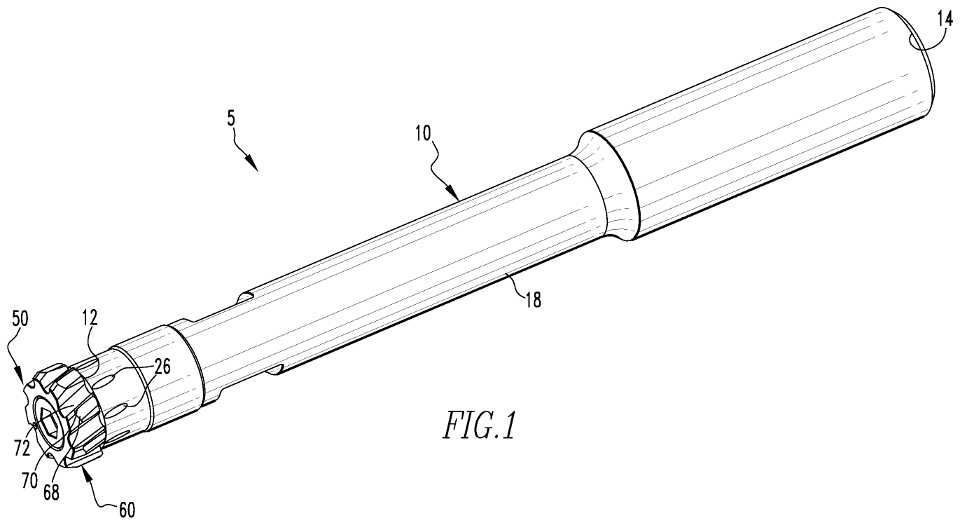

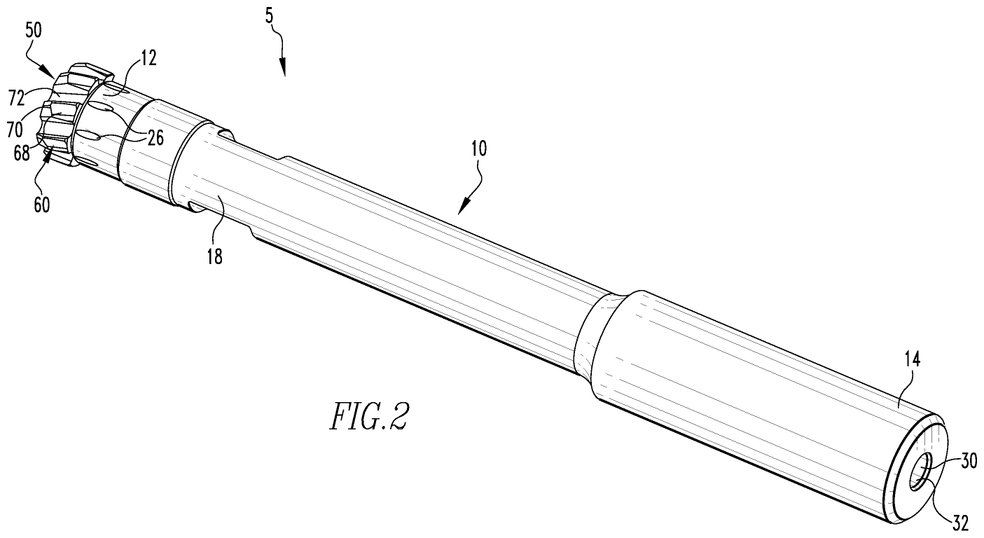

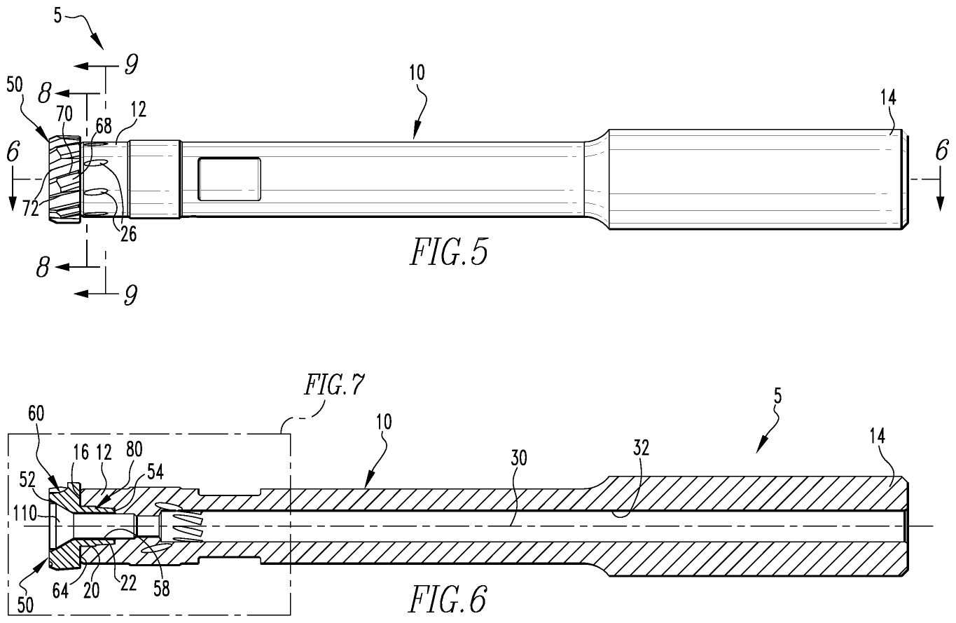

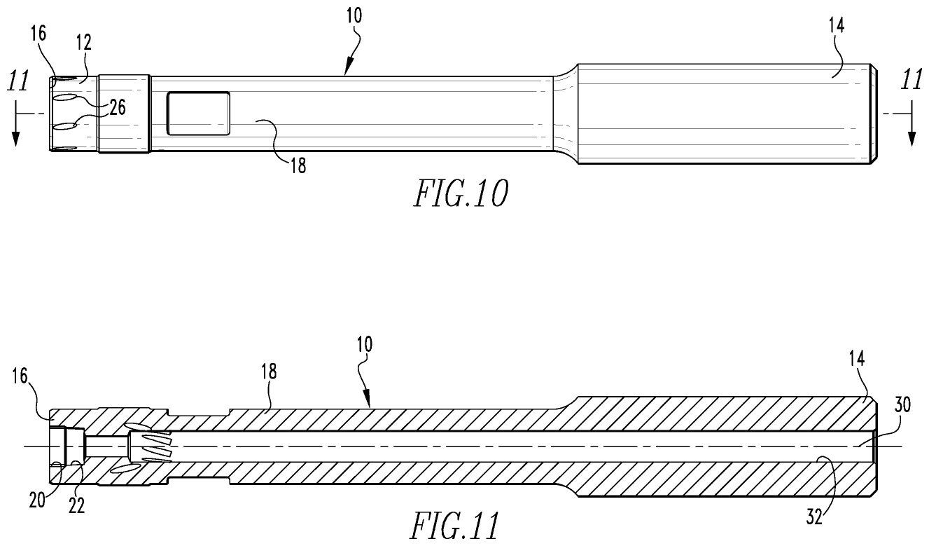

FIG. 1 illustrates a reamer cutting disc and tool body assembly 5 in accordance with an embodiment of the present invention. The reamer cutting disc and tool body assembly 5 includes a one-piece cutting disc 50 and a tool body 10. As shown in FIG. 10, the tool body 10 has an axial forward, or top end 12 and an axial rearward, or bottom end 14. The forward end 12 comprises a front face 16, an outer tool surface 18, a first socket portion 20 and a second socket portion 22. In the embodiment shown, the first socket portion 20 and the second socket portion 22 may be shaped and sized to engage the cutting disc 50, as more fully described below and as illustrated in FIGS. 5-8. In the embodiment shown, the first and second socket portions 20 and 22 have different sizes and shapes. However, any other suitable shape and/or arrangement of first and second socket portions may be used. As shown in FIGS. 6 and 11, the tool body 10 comprises a central longitudinal bore 30 having an interior surface 32 adjacent to the second socket portion 22. In accordance with an embodiment of the present invention, the center of the central longitudinal bore 30 corresponds to a longitudinal axis of the tool body 10. As shown in FIGS. 1 and 2, the top end 12 of the tool body 12 may include coolant outlet apertures 26 for delivering coolant and/or lubricant to the exterior surface of the cutting disc 50, as more fully described below. In accordance with an embodiment of the present invention, the rearward end 14 of the tool body 10 is structured and arranged to be inserted into a rotational drive (not shown).

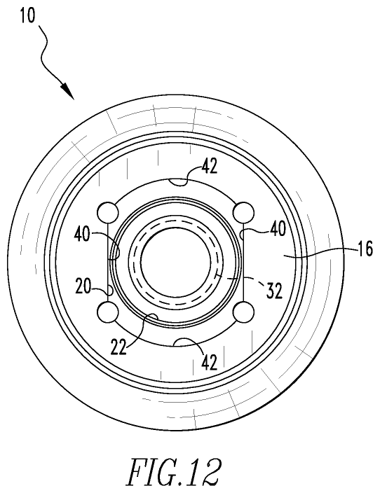

As shown in FIG. 12, the first socket portion 20 comprises at least one flat drive face 40 to abut a corresponding flat drive face of the cutting disc 50, as further described below. In the embodiment shown, the first socket portion 20 comprises opposing flat drive faces 40 connected by opposing arcuate faces 42. However, any other suitable shape may be used, e.g., rectangular, triangular, hexagonal, polygonal or the like.

As shown in FIG. 11, the second socket portion 22 may include an inward conical taper from the first socket portion 20 to the central longitudinal bore 30. In the embodiment shown, the second socket portion 22 is tapered to engage the cutting disc 50, however, any other suitable shape of second socket portion 22 to engage the any suitable shape of cutting disc may be used, e.g., rectangular, square, triangular, ovular, hexagonal, D-shaped or the like.

As shown in FIGS. 1 and 2, the cutting disc 50 is engaged by the tool body 10. The cutting disc 50 has an axial front end 52 and an axial rearward end 54, as shown in FIG. 6. The cutting disc 50 includes a cutting portion 60 adjacent to the axial front end and an integral engagement portion 80 adjacent to the axial rearward end. As shown in FIG. 6, the cutting disc 50 may comprise a generally cylindrical central bore 58 extending through the cutting disc 50. In accordance with an embodiment of the present invention, the center of the generally cylindrical central bore 58 corresponds to a longitudinal axis of the cutting disc 50. In accordance with an embodiment of the present invention, when the cutting disc 50 is engaged with the tool body 10, the longitudinal axis of the cutting disc 50 is generally coaxial with the longitudinal axis of the tool body 10. In certain embodiments, the internal diameter of the cylindrical central bore 58 is selected to allow surface contact between the central clamping screw 110 and the interior surface of the cylindrical central bore 58 along the axial length of the cutting disc 50.

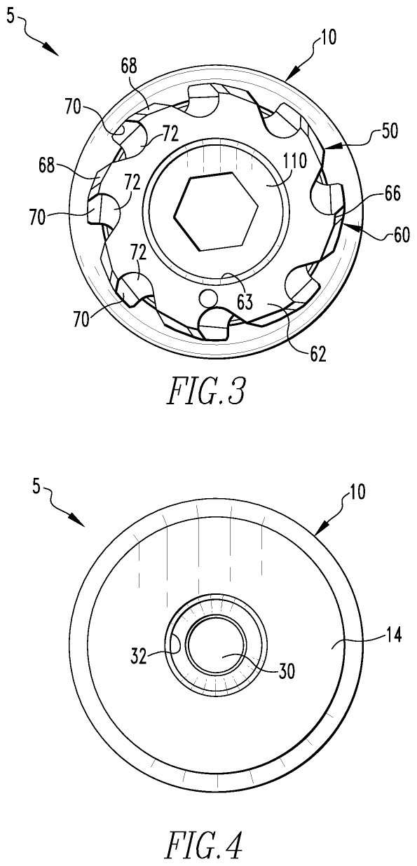

As shown in FIG. 3, the cutting portion 60 may be generally disc-shaped including a generally planar front face 62, a generally planar rear face 64 and a longitudinally-extending outer edge 66. In accordance with an embodiment of the present invention, the cutting portion 60 includes at least one cutting blade 68 comprising a cutting edge 70. In the embodiment shown, there are eight cutting blades 68 and eight cutting edges 70, but any other suitable number of cutting blades and edges may be used. For example, there may be one, two, three, four, five, six, seven, nine, ten or more cutting blades and edges. A flute 72 may be defined between adjacent cutting blades 68, and as shown in FIGS. 3 and 14-16, the flutes 72 may alternate with the cutting blades 68 about the longitudinally-extending outer edge 66 of the cutting portion 60. In the embodiment shown, the cutting portion 60 comprises right-hand flutes 72 for rotation in a clockwise direction, however any other suitable type of fluting may be used, e.g., left-hand fluting, straight fluting or the like.

As shown in FIGS. 6 and 13, the engagement portion 80 of cutting disc 50 comprises an engagement shank 82 extending from the generally planar rear face 64 of the cutting portion 60. As shown in FIG. 6, the engagement shank 82 extends from the generally planar rear face in a direction parallel with the longitudinal axis of the cutting disc 50 and coaxial with the longitudinal axis of the tool body 10. In accordance with an embodiment of the present invention, the engagement shank 82 includes a torque transfer portion 84 and an alignment portion 90. In the embodiment shown, the torque transfer portion 84 is located adjacent to the cutting portion 60 and the alignment portion 90 is located axially rearward along the engagement shank 82.

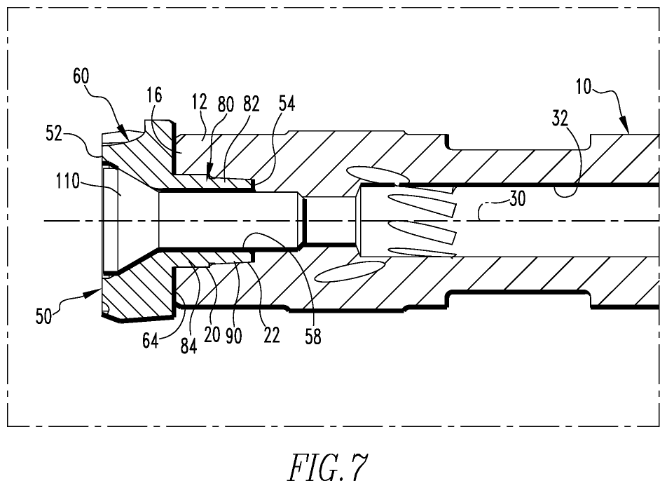

In accordance with an embodiment of the present invention, the torque transfer portion 84 of the engagement shank 82 comprises at least one flat drive face 86 to abut a corresponding flat drive face 40 of the first socket portion 20. As shown in FIGS. 8, 13 and 16, the torque transfer portion 84 may comprise opposing flat drive faces 86 connected by opposing arcuate faces 88 to correspond to the opposing flat drive faces 40 and the opposing arcuate faces 42 of the first socket portion 20 of the tool body 10. The torque transfer portion 86 having an outer surface complementary to inner surface of the first socket portion 20 provides rigid and stable contact to allow for play-free driving rotation. In accordance with an embodiment of the present invention, the torque transfer portion 84 of the engagement shank 82 may be configured to form a slip fit with the first socket portion 20 of the tool body 10 to allow for a rigid connection. However, any other suitable type of fit between the torque transfer portion 84 and the first socket portion 20 may be used, such as, a slide fit, a press fit, or the like. In the embodiment shown, the flat drive faces of the cutting disc 50 and the tool body are used to transmit torque, however, in accordance with another embodiment of the present invention, a drive pin may be used to transmit torque. For example, a hole may be formed in the generally planer rear face 64 of the cutting portion 60 of the cutting disc 50 and corresponding hole may be formed in the front face 16 of the tool body 10 to receive a steel drive pin.

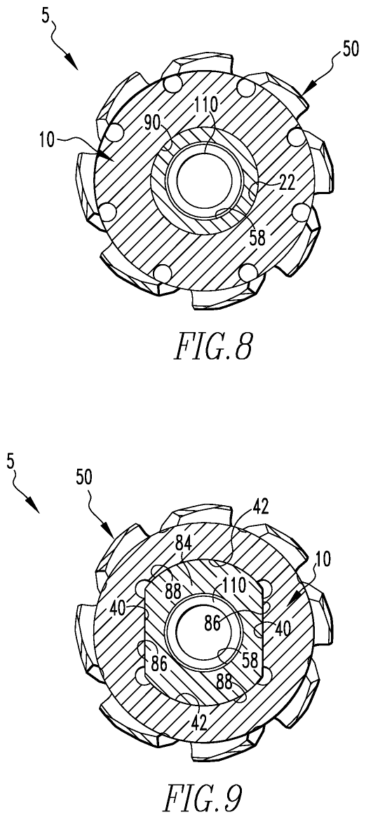

As shown in FIGS. 6, 13 and 14, the alignment portion 90 may extend from the torque transfer portion 84 in a direction parallel with the longitudinal axis of the cutting disc 50. In the embodiment shown, the alignment portion 90 comprises an inward conical taper to mate with the second socket pocket 22, as shown in FIG. 9. However, any other suitable shape of alignment portion may be used, e.g., cylindrical, rectangular, square, triangular, ovular, hexagonal, D-shaped or the like. In accordance with an embodiment of the present invention, the alignment portion 90 may be configured to form a slip fit with the second socket portion 22 of the tool body 10 to allow for coaxial alignment. In accordance with an embodiment of the present invention, the outer surface 92 of the alignment portion engages or fits within the inner surface 24 of the second socket portion 22 to center the cutting disc 50 on the tool body 10, as shown in FIGS. 6 and 9. However, any other suitable type of fit between the alignment portion 90 and the second socket portion 22 may be used, such as, a slide fit, a press fit, or the like. In accordance with an embodiment of the present invention, the shape of the alignment portion 90 is selected to correspond to the shape of the second socket portion 22 of the tool body 10. The corresponding shapes allows the outer surface 92 of the alignment portion 90 to form a relationship with the inner surface 24 of the second socket portion 22.

As shown in FIGS. 6 and 7, when the cutting disc 50 is engaged with the tool body 10, the front face 16 of the axial forward end 12 of the tool body 10 may be in contact with the rear face 64 of the cutting portion 60 of the cutting disc 50. The contact between the tool body 10 and cutting disc 50 may provide a more rigid connection. In accordance with an embodiment of the present invention, the contact between the tool body 10 and the rear face 64 of the cutting portion 60 of the cutting disc 50 allows for the cutting disc 50 to be formed without internal coolant channels. The proximity of the cutting blades 68 and cutting edges 70 of the cutting disc 50 to the top end 12 of the tool body allows the coolant apertures 26 to be formed on the tool body 10. Internal cooling channels extending between the engagement portion 80 and the cutting portion 60 are therefor avoided. Forming the coolant outlet apertures 26 on the tool body 10 without the necessity of coolant channels in the cutting disc 50 allows for the cutting disc 50 to be stronger and easier to manufacture. In accordance with an embodiment of the present invention, the cutting disc 50 is provided without coolant ducts and/or coolant apertures.

As shown in FIGS. 1, 2 and 5, the coolant outlet apertures 26 are provided on the tool body 10 to direct coolant from the tool body 10 to the external surface of the cutting disc 50. The coolant outlet apertures are configured to supply coolant to diminish excessive heat and remove debris. Directing the coolant from the tool body 10 to an external surface of the cutting disc 50 allows for coolant to be directed to the exterior surface without internal coolant passages formed between the cutting disc 50 and the tool body 10. The lack of internal coolant passages between the cutting disc 50 and the tool body 10 allows for a secure engagement between the engagement shank 82 of the cutting disc 50 and the first and second socket portions 20 and 22 of the tool body 10. In accordance with an embodiment of the present invention, the coolant outlet apertures may direct the coolant toward the recessed flutes 72 of the cutting portion 60. However, the coolant outlet apertures 26 may direct the coolant to any other suitable location, e.g., the cutting blades 68, the cutting edges 70 or the like. In accordance with an embodiment of the present invention, the coolant pressure and flow rates may be modified by varying the size of coolant outlet apertures 26 and/or by including a nozzle.

As shown in FIG. 15, the front face 62 of the cutting portion 60 cutting disc 50 may include a clamping screw recess 63 for receiving a clamping screw. As shown in FIG. 6, in accordance with an embodiment of the present invention, the cutting disc 50 may be clamped on the tool body 10 by means of a central clamping screw 110 which passes centrally through the cylindrical central bore 58 of the cutting disc 50 and is threadingly engaged to internal threads in the central longitudinal bore 30 of the tool body. In accordance with an embodiment of the present invention, the central clamping screw 110 may be sized and arranged to contact the interior surface of the cylindrical central bore 58 of the cutting disc to rigidly secure the cutting disc 50 on the tool body 10. As shown in FIG. 7, there is no spacing or gap between the central clamping screw 110 and the interior surface of the cylindrical central bore 58. This arrangement substantially prevents radial movement of cutting disc 50 when the cutting disc 50 is clamped onto the tool body 10. In the embodiment shown, the cutting disc 50 is clamped onto the tool body 10. However, any other suitable arrangement may be used, e.g., shrink-fit, welding, brazing or the like.

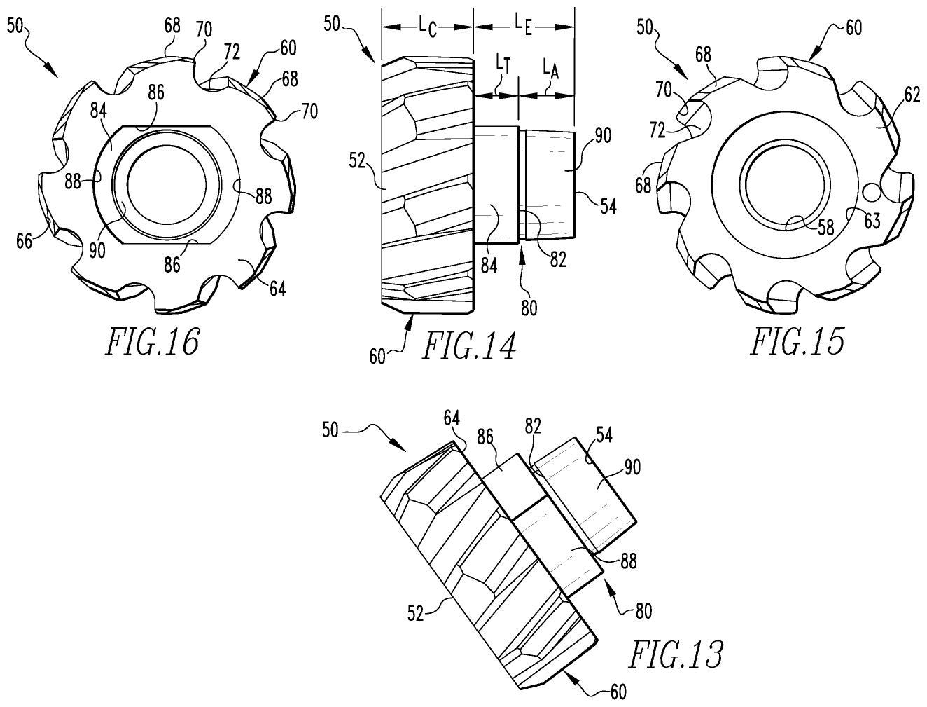

As shown in FIGS. 6 and 14, the engagement shank 82 of the engagement portion 80 extends axially from the cutting portion 60. As shown in FIG. 14, the engagement shank 82 has an axial length L_{E} that allows the engagement shank 82 to extend into the first and second socket portions 20 and 22 of the tool body 10. For example, the axial length L_{E} of the engagement shank 82 may be at least 4 millimeters, for example, from 5 to 36 millimeters or from 6 to 18 millimeters. The axial length L_{E} is selected to allow the engagement shanks to include the torque transfer portion 84 and an alignment portion 90. The torque transfer portion 84 has an axial length L_{T} selected to allow enough contact area between the cutting disc 50 and the tool body 10 for safely transmitting the torque moment. For example, the axial length L_{T} of the torque transfer portion 84 may be at least 2 millimeters, for example, from 2.5 to 18 millimeters or from 3 to 12 millimeters. The alignment portion 90 has an axial length L_{A} selected center the cutting disc 50 on the tool body 10 and protects against lateral forces which may result in the cutting disc 50 and the tool body 10 becoming misaligned. For example, the axial length L_{A} of the alignment portion 90 may be at least 2 millimeters, for example, from 2.5 to 18 millimeters or from 3 to 12 millimeters.

In accordance with an embodiment of the present invention, the axial length L_{T} of the torque transfer portion 84 may be at least 25 percent of the axial length L_{E} of the engagement shank 82. For example, the axial length of the torque transfer portion 84 may be at least 33 percent, or at least 40 percent, or at least 50 percent of the axial length L_{E} of the engagement shank 82. In certain embodiments, the axial length L_{A} of the alignment portion 90 is less than or equal to the axial length L_{T} of the torque transfer portion 84, e.g., at least 5 percent shorter. For example, the ratio of L_{A}:L_{T} may be from 0.5:1 to 2:1, or from 0.75:1 to 1.25:1. In accordance with an embodiment of the present invention, providing the engagement shank 82 with the torque transfer portion 84 and the alignment portion 90 having similar axial lengths allows for a robust engagement between the torque transfer portion 84 and the first socket portion 20 and for alignment portion 90 to mate with the second socket pocket 22. In accordance with another embodiment of the present invention, the axial length L_{A} of the alignment portion 90 may be greater than or equal to the axial length L_{T} of the torque transfer portion 84.

As shown in FIG. 14, the cutting portion 60 of the cutting disc 50 has a length L_{C}. In accordance with an embodiment of the present invention, the cutting portion length L_{C} may be less than or equal to the axial length L_{E} of the engagement shank 82, e.g., at least 5 or 10 percent shorter. For example, the ratio of L_{C}:L_{E} may be from 0.5:1 to 2:1, or from 0.75:1 to 1.25:1. In certain embodiments, the cutting portion length L_{C} is less than 50 percent of a total length of the cutting disc 50. For example, the cutting portion length L_{C} may be less than 45 percent or less than 40 percent of a total length of the cutting disc 50.

The cutting disc 50, including the integral cutting portion 60 and engagement shank 82, may be made of any suitable material, such as cemented carbides and superhard material, such as cubic boron nitride (CBN), polycrystalline cubic boron nitride (PCBN), polycrystalline diamonds (PCD), tungsten carbide (WC), cermet, ceramic, and the like. The cutting disc 50 of the present invention may be fabricated by any suitable technique, such as carbide powder pressing, cutting, milling, molding, drilling, boring, sanding, etching or the like.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

For purposes of the description above, it is to be understood that the invention may assume various alternative variations and step sequences except where expressly specified to the contrary. Moreover, all numbers expressing, for example, quantities of ingredients used in the specification and claims, are to be understood as being modified in all instances by the term “about”. Accordingly, unless indicated to the contrary, the numerical parameters set forth are approximations that may vary depending upon the desired properties to be obtained by the present invention. At the very least, and not as an attempt to limit the application of the doctrine of equivalents, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

1. A reamer cutting disc and tool body assembly comprising:
a tool body comprising an axial forward end having a generally planar front face intersecting with an outer tool surface of the tool body to form a continuous outer diameter, a first socket portion having a continuous inner surface extending from the generally planar front face and a second socket portion adjacent to the first socket portion; and
a reamer cutting disc engageable with the tool body comprising:
a cutting portion comprising a generally planar front face, a generally planar rear face and a longitudinally-extending outer edge; and
an engagement shank extending from the generally planar rear face of the cutting portion comprising a torque transmission portion adjacent to the generally planar rear face and an alignment portion adjacent to the torque transmission portion,
wherein the reamer cutting disc does not include internal coolant channel.

2. The reamer cutting disc and tool body assembly of claim 1, wherein the cutting portion and the engagement shank portion are integrally formed.

3. The reamer cutting disc and tool body assembly of claim 1, wherein the axial forward end of the tool body comprises coolant outlet apertures structured and arranged to direct coolant to an external surface of the cutting portion of the reamer cutting disc.

4. The reamer cutting disc and tool body assembly of claim 3, wherein the axial forward end of the tool body comprises coolant outlet apertures structured and arranged to direct the coolant toward recessed flutes of the cutting portion.

5. The reamer cutting disc and tool body assembly of claim 1, wherein the engagement shank extends axially from the cutting portion.

6. The reamer cutting disc and tool body assembly of claim 1, wherein the first socket portion of the tool body comprises at least one flat drive face, and the torque transmission portion of the reamer cutting disc comprises at least one flat drive face structured and arranged to abut the at least one flat drive face of the first socket portion of the tool body.

7. The reamer cutting disc and tool body assembly of claim 1, wherein the first socket portion of the tool body comprises opposing flat drive faces, and the torque transmission portion of the reamer cutting disc comprises opposing flat drive faces structured and arranged to abut the opposing drive faces of the first socket portion of the tool body.

8. The reamer cutting disc and tool body assembly of claim 1, wherein the second socket portion of the tool body is conically tapered inwardly toward a longitudinal axis of the tool body, and the alignment portion of the reamer cutting disc is conically tapered inwardly toward the longitudinal axis of the tool body to engage the second socket portion.

9. The reamer cutting disc and tool body assembly of claim 1, wherein the generally planar rear face of the reamer cutting disc contacts a front face of the axial forward end of the tool body.

10. The reamer cutting disc and tool body assembly of claim 1, wherein engagement between the engagement shank of the reamer cutting disc and the first and second socket portions does not form an internal coolant passage.

11. The reamer cutting disc and tool body assembly of claim 1, wherein the reamer cutting disc further comprises:
a generally cylindrical central bore extending through the cutting portion and engagement shank of the cutting disc; and
a central clamping screw structured and arranged to contact the interior surface of the cylindrical central bore,
wherein the central clamping screw is threadingly engaged to internal threads in a central longitudinal bore of the tool body.

12. A reamer cutting disc comprising:
a cutting portion comprising a generally planar front face, a generally planar rear face and a longitudinally-extending outer edge; and
an engagement shank integrally formed with the cutting portion extending from the generally planar rear face of the cutting portion comprising a torque transmission portion adjacent to the generally planar rear face, the torque transmission portion comprising first and second flat drive faces formed on opposing radially outer surfaces of the torque transmission portion, and an alignment portion adjacent to the torque transmission portion.

13. The reamer cutting disc of claim 12, wherein the reamer cutting disc does not include internal coolant channels.

14. The reamer cutting disc of claim 12, wherein the engagement shank extends axially from the cutting portion and the alignment portion is conically tapered.

15. The reamer cutting disc of claim 12, wherein the reamer cutting disc is substantially free of steel.

16. The reamer cutting disc of claim 12, wherein the cutting portion has an axial length, the engagement shank has an axial length, the alignment portion has an axial length of from 2.5 to 18 millimeters and the torque transmission portion has an axial length of from 2.5 to 18 millimeters.

17. The reamer cutting disc of claim 16, wherein the axial length of the cutting portion is less than 50 percent of a total length of the cutting disc.

18. The reamer cutting disc of claim 12, wherein an axial length of the torque transmission portion is at least 33 percent of an axial length of the engagement shank.

19. The reamer cutting disc of claim 16, wherein the axial length of the alignment portion is less than or equal to the axial length of the torque transmission portion.

20. The reamer cutting disc of claim 12, wherein the cutting portion comprises at least one recessed flute, at least one cutting blade and at least one cutting edge.
